(19) United States
(12) Patent Application Publication
(10) Pub. No.: US 2013/0204639 A1
(43) Pub. Date: Aug. 8, 2013

(54) INFORMATION SYSTEM FOR STORING, PROCESSING AND DELIVERING UPON REQUEST CLINICAL AND ANAMNESTIC INFORMATION

(71) Applicants: Fabio CORSI, San Biagio alla Cima (IM) (IT); Rodolfo GIANANI, Roma (IT); Rosa CORSI, Roma (IT); Alessio BIANCHERI, San Biagio alla Cima (IM) (IT)

(72) Inventors: Fabio CORSI, San Biagio alla Cima (IM) (IT); Rodolfo GIANANI, Roma (IT); Rosa CORSI, Roma (IT); Alessio BIANCHERI, San Biagio alla Cima (IM) (IT)

(21) Appl. No.: 13/457,343

(22) Filed: Apr. 26, 2012

(30) Foreign Application Priority Data
Feb. 6, 2012 (IT) RM2012U000018

(51) Int. Cl. G06Q 50/24

(52) U.S. Cl. 705/3

(57) ABSTRACT

An information system for storing, processing and delivering upon request clinical and anamnestic information is described. The information system has a first database, a production client of said first database, a terminology database and a server. The information system allows a consultation client to compile a clinical and/or summarized anamnestic history in a certain language selected from a plurality of languages.

### CROSS-REFERENCE TO RELATED APPLICATION

The present application claims priority to Italian Patent Application No. RM2012U000018 filed on Feb. 6, 2012 which is herein incorporated by reference in its entirety.

### FIELD

The present disclosure relates to an information system. In particular it relates to an information system for storing, processing and delivering upon request clinical and anamnestic information.

### SUMMARY

According to a first aspect of the disclosure, an information system for storing, processing and delivering upon request, through a telecommunications network, clinical and anamnestic information is described. The information system comprises a first database configured to store a plurality of data structures, each associated with a respective individual and comprising data identifying the individual and a plurality of specific digital codes, the specific digital codes identifying clinical and/or anamnestic information relating to said individual and being selected from a list of set digital codes obtained from a code conversion of semantic medical terms; a production client of said data structures suitable for interacting with the first database, the production client being configured and programmed to store said data structures in said first database, wherein the production client is configured to convert input information expressed through semantic medical terms into respective digital codes of said list of set digital codes; a terminology database configured to store, for each of said set digital codes, a respective translation into a plurality of languages of said semantic medical terms; a server programmed and configured to receive, from a consultation client through said telecommunications network, a compilation request of a clinical and/or summarized anamnestic history comprising semantic medical terms expressed in a language selected from said plurality of languages, wherein the compilation request carries information relating to said selected language and a code identifying said individual, and wherein the server is programmed and configured to access said data structure, to access a selected set of said specific codes stored in said data structure, to access said terminology database and to provide the consultation client with a set of semantic medical terms expressed in said selected language to generate said clinical and/or summarized anamnestic history.

According to a second aspect of the disclosure, a method for storing, processing and consulting upon request of clinical and anamnestic information is provided. The method comprises providing a first database configured to store a plurality of data structures each associated with a respective individual and comprising data identifying an individual and a plurality of specific digital codes identifying clinical and/or anamnestic information relating to said individual, wherein the specific digital codes are capable of being selected from a list of set digital codes obtained from a conversion of the set digital codes into semantic medical terms; storing in said first database, through a production client suitable for interacting with the first database, said data structures; converting input information expressed through semantic medical terms, storing, in a terminology database for each of said set digital codes of the list, a respective translation in a plurality of languages of said semantic medical terms; receiving, from a consultation client through said telecommunications network and at a server, a compilation request of a clinical and/or summarized anamnestic history having semantic medical terms expressed in a language selected from the languages of said plurality of languages, the compilation request carrying information relating to said selected language and a code identifying said individual; accessing, through said server, a selected set of said specific codes stored in said data structure stored in said database; accessing said terminology database and providing the consultation client with a set of semantic medical terms expressed in said selected language and corresponding to said selected set of specific codes; and generating at said consultation client said clinical and/or summarized anamnestic history.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 is a schematic functional block diagram of an information system for storing, processing and consulting upon request clinical and/or anamnestic information.

FIG. 2 shows schematically a data structure suitable for storing clinical and/or anamnestic information of a patient.

FIG. 3 shows a simplified flow chart of a method for storing, processing and consulting upon request clinical and/or anamnestic information.

### DETAILED DESCRIPTION

There are situations (e.g. emergencies/urgent situations, due to sudden or chronic health problems, accidents or environmental disasters) in which, it can be important to intervene quickly to give treatment to a patient. Such treatments can include but are not limited to carrying out transfusions, carrying out surgery, or carrying out urgent diagnoses. Such treatments can be carried out at a medical facility, for example a first aid station, at which there is often no available health, clinical or anamnestic information on the patient concerned. A problem can be even more serious in cases where a need to assist the patient occurs when the patient is in a different country from their home or in a location different from where they normally live, since there can be additional linguistic problems to overcome, in obtaining anamnestic information in real time.

Problems as described above can result in various drawbacks, more or less serious, and in some cases can put the life of the patient at risk. A first drawback can be the cost since absence of clinical or anamnestic information at the time when it is necessary and/or appropriate to know such information can result in new analyses/diagnoses being carried out that may involve costs to a national health system or directly to the patient.

A second drawback can be a lengthening of intervention times, since before being able to intervene it can be necessary to acquire anamnestic information, by carrying out the new analyses/diagnoses, which can take time. Such lengthening of the intervention times can be a particularly serious problem in urgent/emergency situations.

A third drawback, which can in some cases result in particularly serious consequences, is the possibility that medical staff could make mistakes, which can lead to a risky surgical intervention, an incorrect transfusion in relation to a given blood type, or administration or prescription of drugs incompatible with a state of health of the patient.

Some embodiments of the present disclosure provide an information system and a method for storing, processing and consulting upon request, clinical and anamnestic information that allow drawbacks (e.g. the drawbacks described above) to be at least partially avoided.

Some embodiments of the present disclosure provide a method for storing, processing and consulting upon request clinical and anamnestic information.

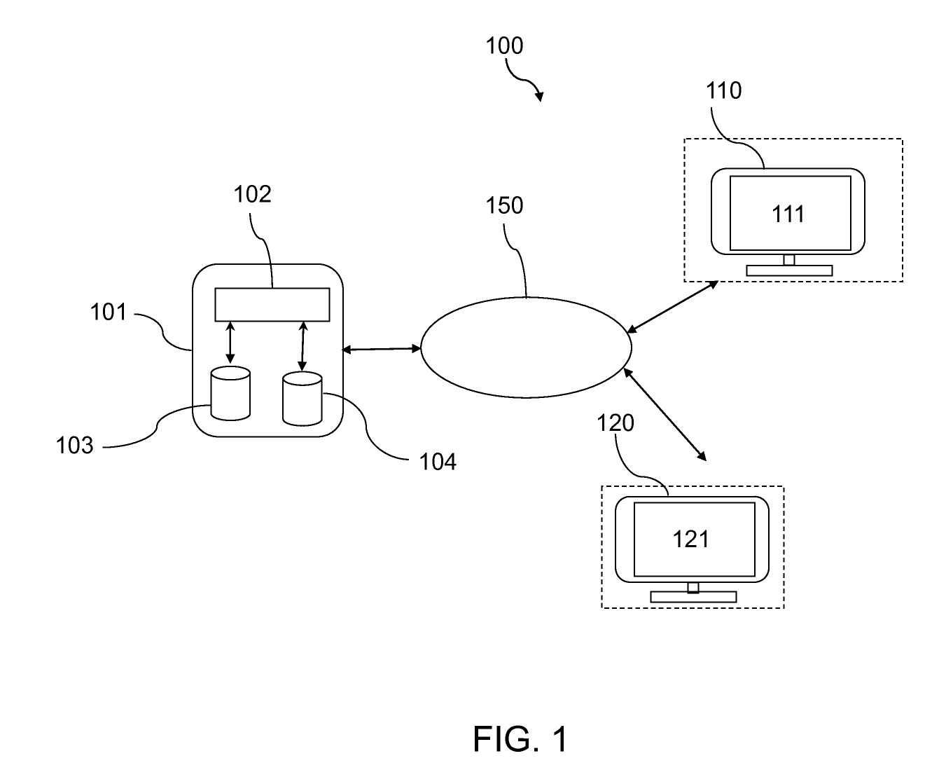

With reference to FIG. 1, reference numeral 100 globally indicates an information system for storing, processing and consulting upon request, through a telecommunications network 150, clinical and/or anamnestic information. In some embodiments, the telecommunications network 150 is the internet. In other embodiments the network 150 is a VPN network.

In some embodiments, the information system 100 comprises a first database 103 configured to store a plurality of data structures 200 each associated with a respective individual. In some embodiments the information system 100 further comprises a server 102 configured to access the database 103.

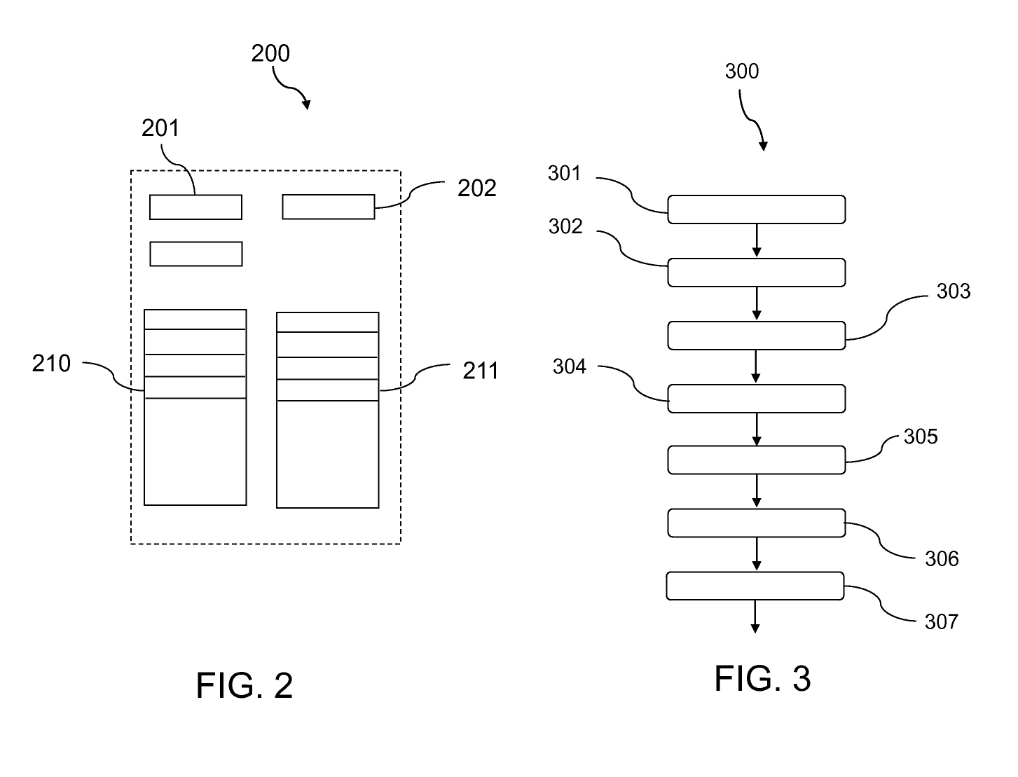

With reference to FIG. 2, which schematically shows the architecture of a data structure 200, each data structure 200 comprises data 201 identifying an individual, like for example personal information of the individual or a user code identifying the individual. For example, the personal information comprises one or more pieces of information which can include but are not limited to forename, surname, date of birth, tax code, address of domicile and residence.

In some embodiments, each data structure 200 comprises contact data of the individual, for example a telephone number and/or an email address.

In some embodiments, each data structure 200 comprises contact information 202, for example, a telephone number and/or an email address, of one or more people (selected by the individual) to be informed in the case of an emergency situation involving the individual.

In some embodiments, each data structure 200 further comprises a plurality of specific digital codes 210, 211 identifying clinical and/or anamnestic information relating to the individual to whom the data structure 200 refers. The specific digital codes 210, 211 are selected from, a list of predefined digital codes obtained from a conversion into code of semantic medical terms, for example names of: pathologies, allergies, active substances, drugs, and/or drug molecules.

In some embodiments the set of all of the specific digital codes of a data structure 200 associated with an individual represents a computerised complete health dossier of said individual. For example, the specific digital codes, e.g. the specific codes for the individual to which the history 200 refers, can be suitable for identifying: family anamnesis information (e.g. information relating to pathologies of the individual's family members including but not limited to parents, grandparents and brothers/sisters); information relating to the individual's past or current pathologies; information relating to possible surgical interventions undergone by the individual; information relating to medical therapies that the individual has undergone or is undergoing, information on medicines taken or to be taken (for example, information in the form of trade names of drugs and/or active substances including information on relative doses) by the individual; information relating to clinical laboratory analyses and examinations; and/or information relating to allergic-type pathologies.

In some embodiments, a field is provided in the data structure 200, the field configured to store at least one pointer or a connection to an image file obtained through diagnostic/analysis methods by images.

With reference to FIG. 1, the information system 100 further comprises a production client 110, 111 of the data structures 200 suitable for interacting with the first database 103, through the server 102.

In some embodiments, the production client 110, 111 is configured and programmed to store, in the first database 103, the data structures 200, and is configured to convert input information expressed through semantic medical terms, (e.g. names of pathologies, allergies, active substances, drugs, and/or drug molecules), into respective digital codes of the list of digital codes.

In some embodiments the production client 110, 111 is a particular combination of hardware/software, and can be used by a doctor, for example a general practitioner, to create and store respective data structures 200 for his patients. For example, the production client 110, 111 can be in the form of a personal computer 110 equipped with a graphical interface 111, a suitable input means (keyboard and/or mouse and/or touchscreen) and a software application through which the doctor can create or update the data structures 200 relating to his patients. In some embodiments, the above can be carried out through a specific software application resident on the personal computer 110 suitable for interfacing with the database 103, through the server 102, or can be carried out through a web portal accessible through the personal computer 110 through which a doctor, interfacing with the database 103 through the server 102, can create/update/consult the data structures 200 associated with his patients.

In some embodiments, the client 110, 111 is equipped with an intuitive and organized user interface configured to allow a doctor to insert the information of an individual, for example one of his patients, in a guided manner, navigating different thematic areas/sections for each of the pieces of information to be inserted, for example, including personal and contact information; family anamnesis information (e.g. information relating to pathologies of the individual's family members, the family members including but not limited to parents, grandparents and brothers/sisters; information relating to the individual's pathologies; information relating to possible surgical interventions undergone by the individual; information relating to medical therapies that the individual has undergone or is undergoing, including information on the drugs/medicines taken or to be taken in relation to such therapies (e.g. information on the drugs/medicines in the form of trade names and/or active substances, including information on the relative doses); information relating to clinical laboratory analyses and examinations undergone by the individual; and information relating to allergic-type pathologies of the individual.

In some embodiments, the production client 110, 111 and the user interface also allow the doctor to load into the database 103 an image file relating to the individual obtained through diagnostic/analysis methods by images and to store in the data structure 200 of the individual a connection or a pointer to such an image file.

For insertion of the information, the production client 110, 111 can be programmed to allow the doctor to compile the data structure 200 of the individual by inserting, selecting, and/or searching for semantic medical terms such as names of pathologies, allergies, active substances, drugs, and/or drug molecules from lists/drop-down menus/trees of predefined terms shown through the graphical interface.

In some embodiments, the production client 110, 111 allows the doctor to insert/add new terms not foreseen and/or present among the predefined terms that can be selected. In some embodiments, the server 102 can be programmed and configured to automatically send off, (e.g. by email), a verification request to an appointed scientific board, which can, for example, decide to match the new term inserted to one of the terms already predefined or it can decide to accept the addition request, inserting the new term into the list of predefined terms. In some embodiments, a new identification code can be associated with the added term.

In some embodiments, the information system 100 further comprises a terminology database 104 configured to store a respective translation of said semantic medical terms into a plurality of languages for each of the predefined digital codes. In some embodiments, the plurality of languages comprises: English, Italian, French, German, Spanish, Russian, Portuguese, Arabic, Chinese, and Japanese.

In an embodiment in which the doctor has added a new semantic term through the production client 110, 111, in a specific language and in which addition of such a term has been validated by the scientific board, the system, (e.g. through the server 102), can be configured to automatically create a new digital code and to automatically send to a translation board or to a company specialised in translation, (e.g. by email), a request to translate the term into any remaining languages, so that the term can be included in the information of the terminology database 104.

In some embodiment, the server 102 is programmed and configured to receive, from a consultation client 120, 121 through the telecommunications network 150, a compilation request of a clinical and/or summarized anamnestic history having semantic medical terms, including, for example, names of pathologies, allergies, active substances, drugs, and/or drug molecules expressed in a language selected from the languages of the plurality of available languages. The consultation client 120, 121 can be, for example, physically arranged at a first aid center, a hospital or an emergency vehicle (e.g. an ambulance). The server 102 can be programmed and configured to receive compilation requests from a plurality of consultation clients 120, 121 which can be in various locations, and in some embodiments, located around the world.

In some embodiments, the compilation request can carry a piece of information relating to the selected language and an identification code 201 of an individual. The server 102 can be programmed and configured to access the data structure 200 associated with the individual, to access a selected set of said specific codes 210 stored in the data structure 200, to access the terminology database 104 and to provide said consultation client 120, 121 with a set of semantic medical terms expressed in the selected language in order to generate, or to allow consultation of, said clinical and/or summarized anamnestic history at the consultation client 120, 121.

In some embodiments, the data structure 200 stored in the database 104 comprises a set of digital codes 210, 211 suitable for providing a complete health dossier of said individual whereas the clinical and/or summarized anamnestic history can be compiled by the server 102 using a subset 210 of said digital codes 210, 211.

In some embodiments, the compilation request can be carried out through said consultation client 120, 121 following the insertion of an emergency password, or code, intended to be held by said individual, for example being printed on a personal card or stored in a chip of a personal card given to the individual, such a password for example being called “password SOS”. The server 102 can be configured to verify whether the password is correct before compiling said clinical and/or summarized anamnestic history. Thus in some embodiments, it is possible, in emergency situations, for example when the individual is admitted to a first aid center, to consult information to give due care/assistance to the individual. Therefore, in some embodiments, the compilation language of the summarized medical history card can be selected so as to immediately have the requested information in a country whose official language is different from the language of compilation of the data structure 200 through the production client 110, 111. In some embodiments, the information system 100 is configured to carry out the consultation through the consultation client 120, 121 through a web portal. In these embodiments, the server 102 can be a web server that in accessing the database 103 and the terminology database 104, allows the received compilation request to be satisfied.

In some embodiments, the server 102, the first database 103 and the terminology database 104 are comprised in a remote information system 101. In these embodiments, clients 110, 111, 120, 121 are able to interact with the remote information system through, for example, an IP browser.

In embodiments in which in there is a field 202 in the data structure 200, suitable for storing contact information of an individual to be alerted in the case of an emergency, the server 102, after receiving a compilation request and after the emergency password has been verified as being correct, can be configured to send off a signal addressed to an individual to be alerted whose contact information is stored in the data structure 200 in response to the compilation request. If, for example, the contact information 202 comprises a telephone number of said individual to be alerted, the signal sent by the server 102 can be an SMS/MMS or voice call signal. If, for example, the contact information 202 comprises an email address, the signal sent by the server 102 can an electronic mail message.

In some embodiments, the server 102 can be programmed and configured to receive, from a consultation client 120, 121 through a telecommunications network 150, a consultation request of a complete health dossier having semantic medical terms, for example names of pathologies, allergies, active substances, drugs, and/or drug molecules, expressed in a language selected from the languages of said plurality of languages. In these embodiments, the consultation request of the complete health dossier carrying information relating to a selected language and the server 102 is configured to: access the data structure 200 of the individual concerned; access the specific codes 210, 211 stored in the data structure 200; access the terminology database 104; and provide the consultation client 120, 121 with a set of semantic medical terms expressed in said selected language in order to generate said complete health dossier.

In some embodiments, the consultation request of the complete health dossier can be carried out through the consultation client 120, 121 following the insertion of a consultation password, distinct from the emergency password, intended to be held by said individual. In these embodiments, the server 102 is configured to verify that said consultation password is correct before providing the consultation client 120, 121 with information suitable for consulting said complete health dossier.

In some embodiments, in terms of a management of the service that can be implemented through an information system 100, there can be an operator responsible for managing the server 102, the databases 103, 104, the production clients 110, 111 and the consultation clients 120, 121, and to provide doctors, for example through a network of drug representatives, with software and/or access to software forming the basis of the production client 110, 111 (e.g. a remote specific application or a web portal).

In some embodiments, the software of the production client 110, 111 can be configured to allow the doctor to insert a group of patients to whom the operator can then offer the service and create the relative data structures 200. I

In some embodiments, the operator can send a commercial offer for the supply of a service to patients of the group, for example by periodical subscription (e.g. yearly). If a patient decides to subscribe to the service the operator can send the patient consultation credentials to access the service through the consultation client and a personal membership card with a unique emergency code or password.

In some embodiments, the operator can pay the doctors based on a number of contracts stipulated. In these embodiments, the production client 110, 111 allows the doctor to compile and send a computerized invoice to the operator. The same software of the production client 110, 111 can be configured to allow the doctor to see the contracts close to expiration so that he can remind his patients to renew the contract with the operator.

In some embodiments, the consultation client 120, 121 can be in the form of a web-accessible portal, with a main page that shows a list of available languages. By selecting one of the languages, a window or a new page can open in which a code of the card can be inserted for compiling the computerised clinical-summarized anamnestic history in emergency situations that involve the individual.

In some embodiments, the portal of the consultation client 120, 121, again after the selection of the language, can allow access to a user area in which the user, through the consultation credentials, can consult his complete health dossier.

The description given above for the information system 100 can also corresponds to the description of a method 300 for storing, processing and consulting upon request, clinical and anamnestic information.

With reference to FIG. 3, the method 300 comprises the steps of: providing a first database 103 configured to store a plurality of data structures 200 each associated with a respective individual, each data structure 200 comprising data 201 identifying an individual and a plurality of specific digital codes 210, 211 identifying clinical and/or anamnestic information relating to said individual, the specific digital codes 210, 211 capable of being selected from a list of predefined digital codes obtained from a conversion into code of semantic medical terms, including for example names of pathologies, allergies, active substances, drugs, and/or drug molecules; storing 302 in said first database 103, through a production client 110, 111 suitable for interacting with the first database 103, said data structures 200, converting input information expressed through semantic medical terms, including, for example, names of pathologies, allergies, active substances, drugs, and/or drug molecules into said digital codes; storing 303, in a terminology database 104 for each of said predefined digital codes, a respective translation in a plurality of languages of said semantic medical terms; receiving 304, from a consultation client 120, 121 through said telecommunications network 150 and at a server 102, a compilation request of a clinical and/or summarized anamnestic history having semantic medical terms, including, for example, names of pathologies, allergies, active substances, drugs, drug molecules expressed in a language selected from the languages of said plurality of languages, the compilation request carrying information relating to said selected language and a code 201 identifying said individual; accessing 305, through said server 102, a selected set of said specific codes 210 stored in said data structure 200 stored in said database 103; accessing 306 said terminology database 104 and providing the consultation client 120, 121 with a set of semantic medical terms expressed in said selected language and corresponding to said selected set of specific codes; and generating 307, for example by video and/or as a text file capable of being viewed/saved/printed, at said consultation client 120, 121, said clinical and/or summarized anamnestic history.

In some embodiments, said data structure comprises a set of digital codes suitable for providing a complete health dossier of said individual and the clinical and/or summarized anamnestic history is generated at said consultation client on the base of a subset 210 of said digital codes 210, 211.

In some embodiments, said plurality of languages comprises English, Italian, French, German, Spanish, Russian, Portuguese, Arabic, Chinese, and Japanese.

In some embodiments, the compilation request is carried out through the consultation client following the insertion of an emergency password intended to be held by said individual, and the method comprises a step of checking with the server 102 whether said password is correct.

In some embodiments, the method 300 further comprises a step of receiving at the server 102 and from a consultation client 120, 121 through a telecommunications network 150, a consultation request of the complete health dossier having semantic medical terms, for example, including pathologies, names of allergies, active substances, drugs, and/or drug molecules expressed in a language selected from the languages of said plurality of languages.

In some embodiments, the consultation request of the complete health dossier carries information relating to said selected language, and the method comprises the steps of: accessing with said server said data structure 200, said specific codes 210, 211 stored in the data structure 200, and said terminology database 104; and providing through said server to said consultation client 120, 121 a set of semantic medical terms expressed in said selected language in order to generate said complete health dossier; wherein the consultation request of the complete health dossier is capable of being carried out through said consultation client 120, 121 following insertion of a consultation password, distinct from said emergency password, intended to be held by said individual.

In some embodiments, the data structure 200 comprises a field 202 suitable for storing contact information of an individual to be alerted in the case of an emergency and the method 300 comprises the steps of: checking at said server 102 the correctness of the emergency password; and sending off with said server a signal addressed to said individual to be alerted.

Further features of the aforementioned method 300 can be identified from the description that has already been given for the information system 100.

The examples set forth above are provided to give those of ordinary skill in the art a complete disclosure and description of how to make and use the embodiments of the Information System For Storing, Processing And Delivering Upon Request Clinical And Anamnestic Information of the disclosure, and are not intended to limit the scope of what the inventors regard as their disclosure. Modifications of the above-described modes for carrying out the disclosure can be used by persons of skill in the art, and are intended to be within the scope of the following claims.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications can be made without departing from the spirit and scope of the present disclosure. Accordingly, other embodiments are within the scope of the following claims.

What is claimed is:

1. An information system for storing, processing and delivering upon request, through a telecommunications network, clinical and anamnestic information, the information system comprising:
a first database configured to store a plurality of data structures, each associated with a respective individual and comprising data identifying the individual and a plurality of specific digital codes, the specific digital codes identifying clinical and/or anamnestic information relating to said individual and being selected from a list of set digital codes obtained from a code conversion of semantic medical terms;
a production client of said data structures suitable for interacting with the first database, the production client being configured and programmed to store said data structures in said first database, wherein the production client is configured to convert input information expressed through semantic medical terms into respective digital codes of said list of set digital codes;
a terminology database configured to store, for each of said set digital codes, a respective translation into a plurality of languages of said semantic medical terms;
a server programmed and configured to receive, from a consultation client through said telecommunications network, a compilation request of a clinical and/or summarized anamnestic history comprising semantic medical terms expressed in a language selected from said plurality of languages, wherein the compilation request carries information relating to said selected language and a code identifying said individual, and wherein the server is programmed and configured to access said data structure, to access a selected set of said specific codes stored in said data structure, to access said terminology database and to provide the consultation client with a set of semantic medical terms expressed in said selected language to generate said clinical and/or summarized anamnestic history.

2. The information system according to claim 1, wherein the data structure comprises a set of digital codes suitable for providing a complete health dossier of said individual and wherein said clinical and/or summarized anamnestic history is compiled by said server based on a subset of said digital codes.

3. The information system according to claim 1, wherein said plurality of languages comprises: English, Italian, French, German, Spanish, Russian, Portuguese, Arabic, Chinese, and Japanese.

4. The information system according to claim 1, wherein the server, the first database, and the second database are comprised in a remote information system configured to allow said clients to interact with the remote information system through an IP browser.

5. The information system according to claim 1, wherein the compilation request is carried out through the consultation client following an insertion of an emergency password intended to be held by said individual, and wherein the server is configured to check whether said password is correct before compiling said clinical and/or summarized anamnestic history.

6. The information system according to claim 5, wherein said data structure comprises a field suitable for storing contact information of an individual to be alerted in the case of an emergency and wherein said server, after receiving said compilation request and when the emergency password has been correctly identified, is configured to send off a signal addressed to the individual to be alerted in response.

7. The information system according to claim 6, wherein said contact information comprises a telephone number and wherein said signal is an SMS/MMS or a voice call signal.

8. The information system according to claim 5, wherein the server is programmed and configured to receive, from a consultation client through a telecommunications network, a consultation request of the complete health dossier having semantic medical terms expressed in a language selected from a languages of said plurality of languages, said consultation request of the complete health dossier carrying information relating to said selected language, wherein the server is configured to access said data structure, to access said specific codes stored in the data structure, to access said terminology database and to provide said consultation client with a set of semantic medical terms expressed in said selected language to generate said complete health dossier, wherein the consultation request of the complete health dossier is capable of being carried out through said consultation client following the insertion of a consultation password, distinct from said emergency password, intended to be held by said individual.

9. A method for storing, processing and consulting upon request of clinical and anamnestic information comprising:
providing a first database configured to store a plurality of data structures each associated with a respective individual and comprising data identifying an individual and a plurality of specific digital codes identifying clinical and/or anamnestic information relating to said individual, wherein the specific digital codes are capable of being selected from a list of set digital codes obtained from a conversion of the set digital codes into semantic medical terms;
storing in said first database, through a production client suitable for interacting with the first database, said data structures;
converting input information expressed through semantic medical terms,
storing, in a terminology database for each of said set digital codes of the list, a respective translation in a plurality of languages of said semantic medical terms;
receiving, from a consultation client through said telecommunications network and at a server, a compilation request of a clinical and/or summarized anamnestic history having semantic medical terms expressed in a language selected from the languages of said plurality of languages, the compilation request carrying information relating to said selected language and a code identifying said individual;
accessing, through said server, a selected set of said specific codes stored in said data structure stored in said database;
accessing said terminology database and providing the consultation client with a set of semantic medical terms expressed in said selected language and corresponding to said selected set of specific codes; and
generating at said consultation client said clinical and/or summarized anamnestic history.

10. The method of claim 9, wherein said data structure comprises a set of digital codes suitable for providing a complete health dossier of said individual and wherein said clinical and/or summarized anamnestic history is generated at said consultation client on the base of a subset of said digital codes.

11. The method of claim 9, wherein said plurality of languages comprises: English, Italian, French, German, Spanish, Russian, Portuguese, Arabic, Chinese, and Japanese.

12. The method of claim 9, wherein the compilation request is carried out through the consultation client following the insertion of an emergency password held by said individual, and wherein the method comprises a step of checking with said server whether said password is correct.

13. The method of claim 12, comprising a step of receiving at the server and from a consultation client through a telecommunications network, a consultation request of the complete health dossier having semantic medical terms expressed in a language selected from the languages of said plurality of languages, said consultation request of the complete health dossier carrying information relating to said selected language, the method comprising the steps of:
accessing with said server said data structure, said specific codes stored in the data structure, and said terminology database;
providing through said server to said consultation client, a set of semantic medical terms expressed in said selected language in order to generate said complete health dossier;
wherein the consultation request of the complete health dossier is capable of being carried out through said consultation client following the insertion of a consultation password, distinct from said emergency password, held by said individual.

14. The method of claim 12, wherein said data structure comprises a field configured for storing contact information of an individual to be alerted in the case of an emergency and wherein said method comprises the steps of:
checking at said server the correctness of the emergency password;
sending off with said server a signal addressed to said individual to be alerted.

15. The method according to claim 1, wherein the semantic medical terms comprise names of pathologies, allergies, active substances, drugs, and/or drug molecules.

16. The method according to claim 8, wherein the semantic medical terms comprise names of pathologies, allergies, active substances, drugs, and/or drug molecules.

17. The method according to claim 9, wherein the semantic medical terms comprise names of pathologies, allergies, active substances, drugs, and/or drug molecules.

18. The method according to claim 13, wherein the semantic medical terms comprise names of pathologies, allergies, active substances, drugs, and/or drug molecules.
